(19) United States
(12) Patent Application Publication
(10) Pub. No.: US 2024/0419164 A1
(43) Pub. Date: Dec. 19, 2024

(54) IOT AND SENSOR FEED ANALYSIS BASED MACHINE MAINTENANCE

(71) Applicant: INTERNATIONAL BUSINESS MACHINES CORPORATION, Armonk, NY (US)

(72) Inventors: Jill S. Dhillon, Jupiter, FL (US); Jeremy R. Fox, Georgetown, TX (US); Tushar Agrawal, West Fargo, ND (US); Sarbajit K. Rakshit, Kolkata (IN)

(21) Appl. No.: 18/211,340

(22) Filed: Jun. 19, 2023

(51) Int. Cl. G05B 23/02

(52) U.S. Cl. CPC G05B 23/0283; G05B 23/0291

(57) ABSTRACT

A computer-implemented method, system, and computer program product to create optimized maintenance plans to reduce machine downtime for IoT machine. The method may include determining one or more sets of minimum functionalities required to perform an activity. The method may also include determining machines capable of supporting the one or more sets of minimum functionalities. The method may also include determining a minimal level of maintenance for the machines. The method may also include generating a maintenance plan for one or more of the machines based on the minimal level of maintenance for the machines.

### BACKGROUND

The present disclosure relates to internet of things (IoT) and, more specifically, to creating optimized maintenance plans to eliminate or reduce machine downtime for IoT machines.

The internet of things (IoT) is a system of interrelated computing devices, mechanical or digital machines, sensors, etc. The various devices, sensors, machines, etc. may be connected through a computer network. IoT allows for the ability to transfer data over computer networks without requiring human-to-human and/or human-to-computer interaction. An IoT system can include internet-enabled devices that use processors, sensors, and/or communication hardware to collect, send, and act on data received through the IoT environment.

### SUMMARY

The present invention provides a computer-implemented method, system, and computer program product to create optimized maintenance plans to reduce machine downtime for IoT machine. The method may include determining one or more sets of minimum functionalities required to perform an activity. The method may also include determining machines capable of supporting the one or more sets of minimum functionalities. The method may also include determining a minimal level of maintenance for the machines. The method may also include generating a maintenance plan for one or more of the machines based on the minimal level of maintenance for the machines. The system and computer program product may include similar steps.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram of a computing environment suitable for creating and generating optimized machine maintenance plans, according to some embodiments.

FIG. 2 depicts a method for generating and updating a machine maintenance plan, according to some embodiments.

FIG. 3 depicts a method for determining one or more sets of minimum functionalities, according to some embodiments.

FIG. 4 depicts a method for generating a maintenance plan, according to some embodiments.

FIG. 5 depicts a schematic diagram of an example IoT environment, according to some embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to internet of things (IoT) and, more specifically, to creating optimized maintenance plans to eliminate or reduce machine downtime for IoT machines. While the present disclosure is not necessarily limited to such applications, various aspects of the disclosure may be appreciated through a discussion of various examples using this context.

Technologies, such as internet of things (IoT) may be used to connect various entities. For example, various machines, equipment, and/or devices may be connected through IoT. For the case of simplicity, machines, equipment, devices, etc. may all be referred to herein as machines.

Machines may require maintenance from time to time. However, when a part of a machine needs maintenance, the entire machine may have to be shut down for maintenance in conventional systems, even if only a small part of the machine needs maintenance. For instance, various types of machines (such as robots, metal cutting machines, etc.) may be able to perform multiple functionalities and activities. Functionalities, as referred to herein, are functions and/or capabilities of a machine that complete an action/activity. An activity may be broken up into tasks. An activity, as referred to herein, may be an action, event, etc. that is carried out in a sequential set of tasks on one or more machines.

To complete an action/activity, different types of machine functionalities may be required. However, to complete a task, a single machine functionality may be required, in some instances. In some instances, a single task may require multiple machine functionalities. For instance, as referred to herein, a machine may execute a functionality (or functionalities) in order to perform a task. For example, a waterjet machine may complete the activity of cutting a material. In this example, the activity of cutting a material may include different tasks such as automatically placing the item, securing the item, executing the water jet, etc. To complete the cutting task, for example, different machine functionalities such as a water jet, water chiller, power supply, etc. may all be used to complete the cutting. In some instances, each task may use different machine functionalities. In some instances, multiple tasks may use a same functionality. For instance, the same machine functionality (for example, clamps/clamping) may both place and secure the item, therefore executing multiple tasks using the same machine functionality. In some instances, a single task may use multiple functionalities. For example, a task of executing a water jet may use both water stream and water chiller functionalities.

In some instances, only one functionality (or only some of the functionalities) may need to undergo maintenance. For instance, one machine may be able to perform five different functionalities, and there may only be a problem with one functionality and only that one functionality may need maintenance (and, in some instances, one or more of the parts/portions of the machine related to that one functionality). For example, the water chiller functionality of a waterjet machine may need maintenance, however the waterjet machine may have multiple functionalities in addition to the water chiller. However, in conventional systems, the entire waterjet machine may undergo maintenance even though only one functionality needs maintenance.

With the increases in technology capabilities, the entire maintenance detection process, as well as the performing of maintenance, may be an automatic process. For example, robots/bots may be able to automatically perform maintenance on machines. However, as discussed herein, in conventional systems the entire machine may need to go down in order to undergo maintenance, even though only a small portion of the machine (for example, one functionality of the machine) may actually need maintenance. This may cause unnecessary downtime for the machine and unnecessary delays (and in some instances, even cancellations) for the activities performed by the machine. Further, conventional systems may simply shut down the machine and perform maintenance once it is detected that the machine needs maintenance, or may add the machine to a list of machines that need maintenance, and simply have the machine undergo maintenance when it is next on the list, without factoring in the activities of the machine, their upcoming activities and/or operations, etc. This may result in machines being shut down for maintenance at non-ideal times, which may cause delays or even cancellations in operations/activities performed by those machines.

For example, a first machine may have two functionalities (functionality 1 and functionality 2) and a second machine may have a third functionality (functionality 3). In this example, an activity may include three tasks (task 1, task 2, and task 3) and each task may correspond to a functionality (for example, task 1 corresponds to functionality 1, task 2 corresponds to functionality 2, and task 3 corresponds to functionality 3). In this example, functionality 1 from the first machine (or part(s) of the machine corresponding to functionality 1) may need maintenance, so the first machine may not be able to perform task 1. However, in this example, there may be a third machine that also has functionality 1. In a conventional system, the first machine may go down for maintenance, and the activity may be delayed as both functionalities 1 and 2 cannot be executed (and task 1 cannot be performed) until the first machine is running again. However, it may have been unnecessary for the first machine to go down for maintenance, as the third machine could have been added to the activity to perform task 1 (as the third machine also has functionality 1) and the first machine could have continued running in order to execute functionality 2 (and perform task 2). Further, even if a third machine were not accessible, the downtime of the first machine could have been coordinated so that the first machine was down for maintenance while the second machine was executing functionality 3 to perform task 3 and the first machine was not in use, in order to prevent delays, disruptions, or cancellations to the activity.

The present disclosure provides a computer-implemented method, system, and computer program product to create optimized maintenance plans to eliminate or reduce machine downtime for IoT machines. For instance, as discussed herein, not all the capabilities and/or parts of a machine may need maintenance at the same time. Therefore, in some instances, the machine may still be able to execute its other capabilities while one capability is undergoing maintenance. In some instances, even if an entire machine may need to have down time to undergo maintenance, the machine may be able to be shut down for maintenance at a time when it is not being utilized, therefore preventing delay or stoppage of the activities/operations executed by the machines.

For example, the process of pressing a metal may include a first functionality on a first machine, a second functionality on a second machine, and a third functionality on a third machine. In this example, the order of execution of the functionalities may be the first functionality, then the second functionality, and then the third functionality. However, in this example, the first machine may need to undergo maintenance and may need to be fully shut down to undergo said maintenance. To help prevent any delay or stoppage of the cutting process, the optimized maintenance plan may include shutting down the first machine after it has executed the first functionality. Therefore, the first machine may be undergoing maintenance while the second and third machines are executing the second and third functionalities, respectively. This way, the first machine may undergo maintenance at a time it is not needed in the cutting process, therefore allowing the pressing process to continue and preventing any delay or stoppage of the cutting process. Or, for example, there may be another machine (for example, the second machine, the third machine, or a fourth machine) that includes the first functionality. In this example, the first machine may be able to undergo maintenance and the first functionality can be transferred to another machine capable of executing the first functionality. This way, the first machine can undergo maintenance and the cutting process can still continue without delay.

In another example, the pressing functionality of the first machine may need maintenance as it may only be pressing with half the force the machine is typically able to press with. However, in this example, there may only be two items left to be pressed before the first machine (or at least the pressing functionality of the first machine) has a period of time where it is not utilized. Therefore, in this example, the optimized maintenance plan may be to continue executing the first machine to press the last two items, but to use the pressing functionality twice for each item (as the machine is only able to press with half the force as it typically can) in order to achieve the same result as when the machine is functioning at its full capability. Then, after the last two items are pressed, the optimized maintenance plan may then be to perform maintenance on the pressing functionality of the first machine. This way, unnecessary downtime and delays in activities are avoided, as maintenance on the pressing functionality of the first machine is performed at a time where the first machine and/or pressing functionality of the first machine was not being utilized.

In another example, the first machine may need to undergo maintenance, but the maintenance may be to a part related to a fourth functionality executed on the first machine. As the fourth functionality may not be needed for the cutting process, the pressing process (and its corresponding first, second, and third functionalities) may be executed on the first, second, and third machines, even while the part(s) related to the fourth functionality on the first machine are undergoing maintenance.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as creating and generating optimized maintenance plans of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

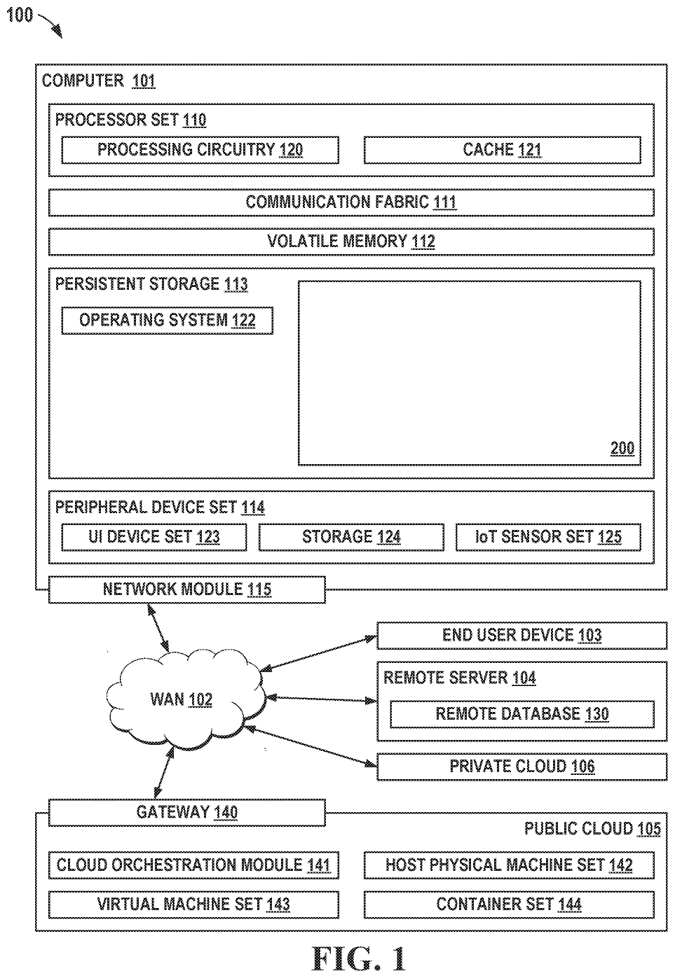

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

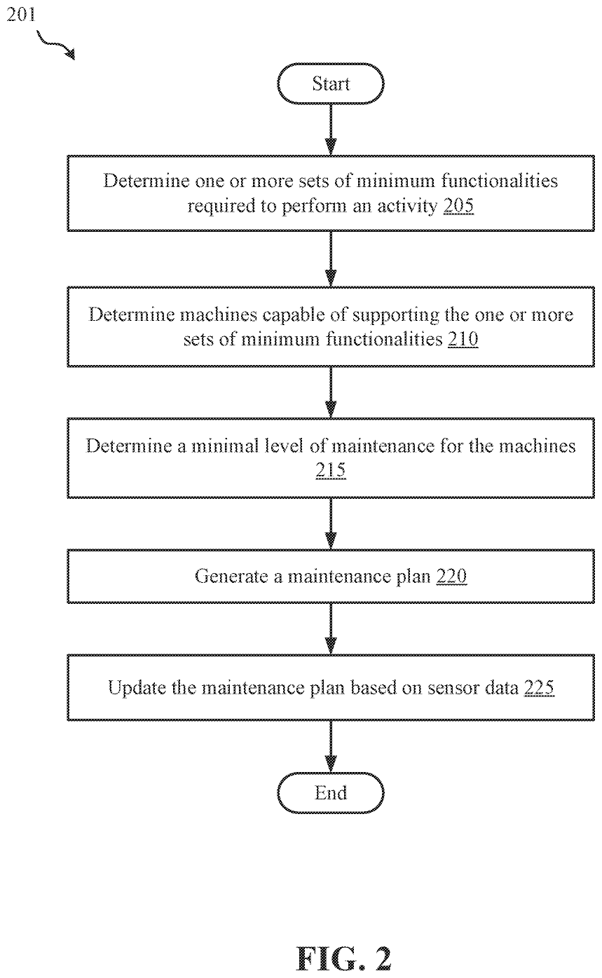

Referring now to FIG. 2, a method 201 for generating and updating an optimized machine maintenance plan is depicted, according to some embodiments. As discussed herein, without an optimized machine maintenance plan, a machine may undergo maintenance at a non-optimal time and/or the entire machine may go down for maintenance when only a portion of the machine may actually need maintenance, which may cause unnecessary downtime for the machine and unnecessary delays (and in some instances, even cancellations) for the activities performed by the machine. An optimized maintenance plan may allow a machine to be able to execute its other capabilities while one capability is undergoing maintenance and/or shut down a machine for maintenance at a time when it is not being utilized, therefore preventing delay or stoppage of the activities/operations executed by the machines.

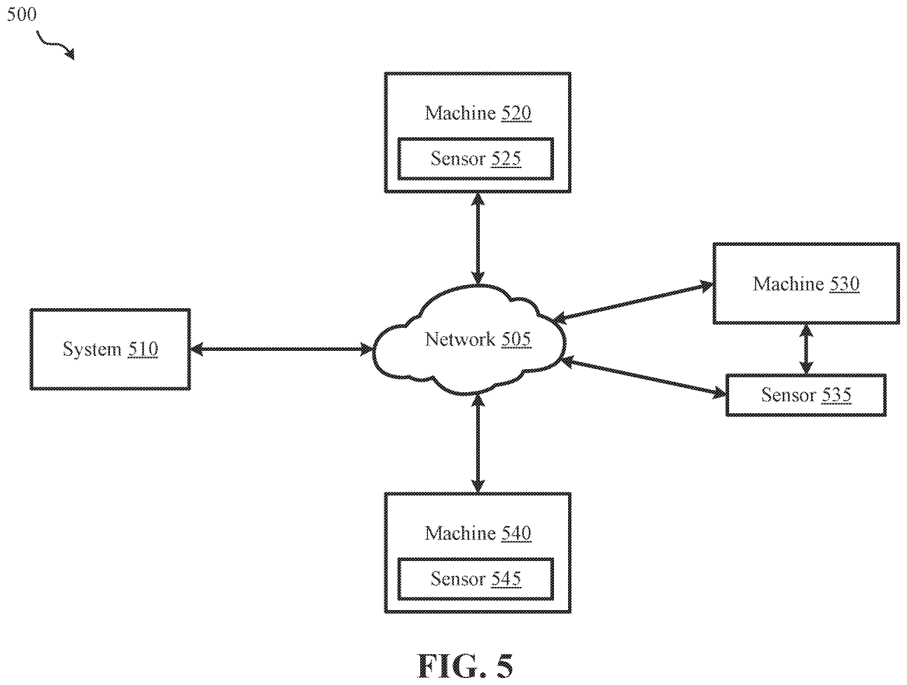

In some instances, method 201 may be executed by a server on or connected to a computing environment (e.g., computing environment 100) and/or a computer (e.g., computer 101). In some embodiments, the method 201 is implemented as a computer script or computer program (e.g., computer executable code) to be executed on or connected to the computing environment and/or computer. In some embodiments, method 201 is executed on a computer system within a cloud computing environment (e.g., public cloud 105 and/or private cloud 106). In some embodiments, method 201 is executed on a system such as system 510 (FIG. 5). In some instances, the server, computer program, computer system, etc. executing method 201 may be part of a larger system such as a factory, an assembly line, a fabrication plant, etc.

Method 201 includes operation 205 to determine one or more sets of minimum functionalities required to perform an activity. Minimum functionalities required to perform an activity may be the fewest amount of functions/capabilities necessary to perform an activity. For example, an activity may be to create an object. To perform this activity, there may be tasks such as pressing a first material, moving the first pressed material from location A to location B (for example, from a first machine to a second machine, from a first area of the first machine to a second area of the first machine, etc.), pressing a second material, moving the second pressed material from location A to location B, attaching the first pressed material to the second pressed material, and smoothing the surfaces of the attached materials. These tasks may correspond to functionalities, in some instances. For example, the task of pressing the first material may correspond to a functionality of pressing, moving the first pressed material from location A to location B may correspond to a functionality of transporting/moving a material, and so on. In this example, the functionalities necessary to perform the tasks may be pressing, transporting/moving a material, attaching (for example, welding, fusing, drilling, gluing, etc.), and polishing/smoothing, therefore these functionalities may be a set of minimum functionalities.

The tasks of pressing the first material and pressing the second material may correspond to the same functionality, in some instances. In some instances, functionalities such as transporting/moving a material may be determined to not be necessary, as the materials may not necessarily need to be moved in order to be pressed, attached, and polished. Therefore, in this example, the set of minimum functionalities may be pressing, attaching, and polishing/smoothing.

In some instances, determining one or more sets of minimum functionalities may include identifying relationships between tasks (and, in some instances, their corresponding functionalities), such as whether tasks and/or functionalities are sequential and/or parallel. For example, a first task and a second task may be executed one after another, therefore the two tasks may be sequential. In another example, a first task may be to etch a material and a second task may be to polish a material. In this example, a machine may be capable of etching and polishing simultaneously, therefore the first and second tasks may be executed in parallel.

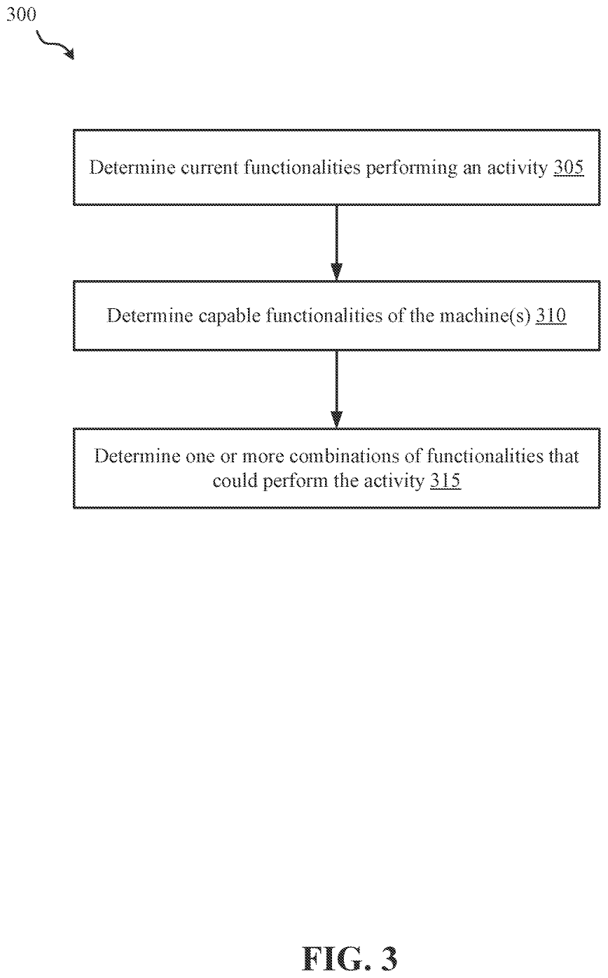

In some instances, determining one or more sets of minimum functionalities required to perform an activity may include determining current functionalities performing the activity (for example, the functionalities that, when maintenance is not being performed, are set to perform the activity), determining which functionalities the various machines (for example, the machines connected to the system) are capable of performing (referred to herein as capable functionalities), and determining one or more combinations of functionalities, from the current functionalities and the capable functionalities, that could perform the activity. In some instances, identifying one or more sets of minimum functionalities may include removing any unnecessary or non-essential functionalities from the one or more combinations of functionalities. Each combination of functionalities may be a set of minimum functionalities, in some instances. In some instances, combinations of functionalities with an amount of functionalities over a threshold amount of functionalities may not be a set of minimum functionalities. For example, a set of functionalities may include 12 functionalities, however, there may be a threshold amount of functionalities of 7. In this example, the set of functionalities with 12 functionalities may not be a set of minimum functionalities, as it may include an amount of functionalities over the threshold amount of 7. These operations may be further discussed herein and depicted in FIG. 3.

Method 201 includes operation 210 to determine machines capable of supporting the one or more sets of minimum functionalities. Machines capable of supporting the minimum functionalities may be the machines that are able to execute the functionalities. For example, a functionality may be laser cutting, and the laser cutting functionality may correspond to a task of cutting a metal. In this example, a laser cutter may be one machine capable of supporting the laser cutting functionality and the task of cutting a metal. However, in this example, there may be other laser cutter machines that may also be capable of supporting the minimum functionality/functionalities.

In some instances, machines capable of supporting tasks corresponding to the one or more sets of minimum functionalities may also be determined. For instance, using the metal cutting example above, the task corresponding to the laser cutting functionality is cutting a metal, as the laser cutting is used to perform the task of cutting the metal. However, in this example, there may also be machines such as a waterjet machine and/or a milling machine that are machines capable of supporting a task corresponding to a minimum functionality, as the waterjet machine and milling machine may also be capable of cutting the metal. Therefore, in this example, the waterjet machine and milling machine may be machines capable of supporting the laser cutting minimum functionality.

In another example, with minimum functionalities of pressing, attaching, and polishing/smoothing, it may be determined that a first machine, a second machine, and a third machine all have pressing functionalities; the third machine and a fourth machine have attaching functionalities; and the second machine has a polishing/smoothing functionality. In this example, identifying machines capable of supporting the minimum functionalities may include identifying the first machine, second machine, third machine, and fourth machine, and determining that the first machine supports the pressing functionality, the second machine supports the pressing and polishing/smoothing functionalities, the third machine supports the pressing and attaching functionalities, and the fourth machine supports the attaching functionality.

In some instances, determining machines capable of supporting the minimum functionalities may include detecting one or more machines, determining the functionalities of the one or more machines, and identifying machines, from the one or more machines, that have functionalities corresponding to (for example, matching) the minimum functionalities. In some instances, as discussed further herein, various machines and sensors may be connected to a system (for example, system 510 (FIG. 5)). Therefore, in these instances, detecting one or more machines may include identifying the one or more machines that are connected to the system. For example, a plurality of machines may be on an industrial floor, in a warehouse, etc. In this example, a system may be connected to the plurality of machines and may, in some instances, control the actions of the plurality of machines. Therefore, in this example, detecting one or more machines may include identifying the plurality of machines connected to the system.

In some instances, because the system may be connected to one or more machines, the system may have knowledge of the functionalities of the one or more machines. For example, each machine may have its own specifications (for example, capabilities, different parts/equipment within the machine, etc.) that were outlined/determined by the manufacturer of the machine, and the system may have access to these specifications. In some instances, the functionalities of the one or more machines may be determined using historical data for the one or more machines.

Method 201 includes operation 215 to determine a minimal level of maintenance necessary to be performed on the machines capable of supporting the minimum functionalities. The minimum level of maintenance may be the smallest amount of maintenance the machine needs to undergo so it can keep performing (for example, keep performing the functionalities to achieve the activity). For example, a waterjet machine may need maintenance. Identifying the minimal level of maintenance may include determining which parts, capabilities, and/or functionalities of the machine need maintenance. In this example, the waterjet machine may have a waterjet that needs maintenance. Therefore, in this example, the minimal level of maintenance may be repairing the waterjet.

In another example, a machine may be a pressing machine that can execute four different kinds of pressing (e.g., flat, texture, etc.), but to perform an activity only flat pressing may be needed. In this example, the machine may be notifying the system that it requires some maintenance, however it may need to be determined whether the machine needs maintenance in order to continue using the machine for flat pressing and whether there are any other machines with flat pressing capabilities. Further, in this example, it may be determined whether one of the other kinds of pressing (for example, texture pressing) can be utilized instead of flat pressing in order to perform the activity.

In some instances, minimal level of maintenance may include maintaining features (such as safety features, ease of use features, etc.) that may not directly perform the activities but, for instance, help maintain the integrity of the machines, protect users and surroundings, etc.

In some instances, determining a minimal level of maintenance necessary to be performed on the machines capable of supporting the minimum functionalities may include determining which machines need maintenance. In some instances, a sensor feed analysis may be performed to help determine when a machine needs maintenance. For example, as discussed further herein, each machine may have (or be connected to) sensors (such as IoT sensors), there may be sensors in the area (for example, throughout a plant, warehouse, industrial floor, etc.), and so on. These sensors may be able to detect various information about the machine(s) and by analyzing the sensor data it may be determined which part(s) of the machine(s) need maintenance. For example, a pressing machine may typically be able to press at a certain force. However, sensors may detect that the pressing machine is only pressing at half of its typical force capabilities. Therefore, based on the sensor data, it may be determined that the press (and specifically, the part(s) of the press that correspond to the force of the press) needs maintenance. In some instances, determining a minimal level of maintenance may include determining which part(s), equipment, functions, etc. of the machine(s) need maintenance. The sensor feed analysis may be used, in some instances, to determine which part(s) of the machine(s) need maintenance. For instance, using the previous example, the sensor feed analysis was used to determine that a pressing machine needed maintenance and that the press (and specifically, the part(s) of the press that correspond to the force of the press) needs maintenance.

In some instances, the machine(s) may have a notification, alert, pop-up, or some other type of indication that the machine(s) need maintenance. In these instances, the notification, alert, pop-up, etc. may be used as an indication that a machine needs maintenance. In some instances, the notification, alert, pop-up, etc. portions of a machine may also be monitored to determine whether those portions of the machine need maintenance. In those instances, sensor feed analysis, for example, may help determine that the notification/alert/pop-up portion of the machine needs maintenance. In some instances, a notification, alert, pop-up, etc. may indicate both the machine(s) that need maintenance and the part(s) of the machine that need maintenance. For example, for a cutting machine, there may be a notification that a first blade on the cutting machine needs to be replaced and/or sharpened. In some instances, a notification, alert, pop-up, etc. may indicate that a machine needs maintenance but not which part(s) of the machine(s) need maintenance. In these instances, other methods, such as a sensor feed analysis, may be used to help determine which part(s) of the machine(s) need maintenance.

In some instances, the minimal level of maintenance necessary to be performed on the machines capable of supporting the minimum functionalities, may be the minimal level of maintenance necessary to continue performing the activity. Therefore, in some instances, determining the minimal level of maintenance may further include determining whether the machine(s) and/or parts of the machine(s) that need maintenance correspond to the activity and/or the one or more sets of minimum functionalities. For example, a machine may have two functionalities (functionality 1 and functionality 2). In this example, functionality 1 may need maintenance, however the one or more sets of minimum functionalities may only utilize functionality 2. Therefore, in this example, the parts of the machine that need maintenance do not correspond to the one or more sets of minimum functionalities. In some instances, it may further be determined whether the machine(s) can continue being run while maintenance is being performed. For example, in some instances, a machine may be able to continue executing functionality 2 while maintenance is being performed on functionality 1. In other instances, a machine may need to be shut down while performing maintenance on functionality 1, even though functionality 2 may not need maintenance.

In some instances, the minimal level of maintenance necessary to be performed may include other essential features of the machine (for instance, essential features not tied to the minimum functionalities) such as safety features, ease of use features, etc.

In some instances, machines may be used to accomplish multiple activities. Therefore, in some instances, determining a minimal level of maintenance may include analyzing interdependencies between activities and machines and determining whether machine(s) are part of multiple activities. Interdependencies, as referred to herein, may be states of mutual dependence between multiple activities, machines, tasks, etc. For example, if two activities may utilize the same machine, the two activities may be interdependent of each other, as the actions/executions of the machine for one activity may affect the actions/executions of the machine for another activity. For instance, if a machine is being executed for a first activity at a first time, the same machine (or the same functionality of the machine) may not also be able to be executed for a second activity at the first time, as the functionality is already being used for the first activity. If a machine is part of multiple activities, determining a minimal level of maintenance may include determining whether a machine needs maintenance to continue performing any of its multiple activities.

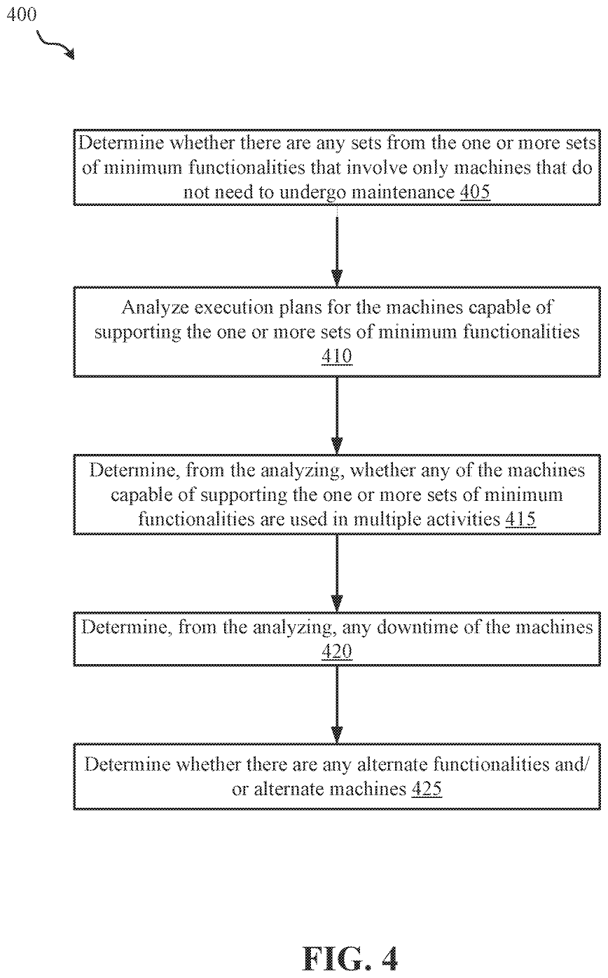

Method 201 includes operation 220 to generate a maintenance plan. In some instances, the maintenance plan may be generated based on the minimal level of maintenance. For instance, a maintenance plan may try and prevent or reduce downtime of a machine while also still performing necessary maintenance on a machine (for example, based on a minimal level of maintenance) so a machine can still perform tasks and execute functionalities. A maintenance plan may include the machine to undergo maintenance, the parts, capabilities, and/or functionalities of the machine that needs maintenance, the time to perform the maintenance, and/or the activity execution plan while a machine and/or part of the machine is undergoing maintenance. For example, if a water jet within a waterjet machine needs maintenance, the maintenance plan may include a requirement to keep executing the waterjet machine, but to run the water jet twice (instead of a typical one time) in order to cut a metal. In this example, the waterjet machine may have scheduled downtime that the machine is not being used in a few hours, therefore the maintenance plan may be to continue running the machine for those few hours (in a way where the machine will still be executing its functions) and then repairing the machine during its downtime. In another example, the maintenance plan may include stopping the waterjet machine and performing maintenance on the waterjet machine, and transferring any functionalities typically executed on the waterjet machine to a milling machine while the waterjet machine is undergoing maintenance. The generated maintenance plan may try to eliminate and/or reduce any downtime of the machines and their functionalities. Generating a maintenance plan may be further discussed in relation to FIG. 4.

In some instances, generating a maintenance plan may include generating a replacement maintenance plan. For instance, there may be a pre-existing maintenance plan for the machine(s). In instances where there is a pre-existing maintenance plan, method 201 may further include analyzing an existing maintenance plan, identifying a problem likely to be caused by the existing maintenance plan, generating a replacement maintenance plan that addresses the problem, and replacing the existing maintenance plan with the replacement maintenance plan. Problems that are likely to be caused by an existing maintenance plan may include machines being shut down for maintenance at non-ideal times, delays or even cancellations in operations/activities performed by machines, unnecessary and/or excessive downtime for maintenance, etc. In some instances, generating a replacement maintenance plan may be done using same/similar methods as generating a maintenance plan.

For example, there may be a machine 1 that has functionality 1, machine 2 that has functionality 2, and machine 3 that has functionality 3. Functionality 1 may correspond to task 1, functionality 2 may correspond to task 2, and functionality 3 may correspond to task 3. In this example, an activity may include task 1, task 2, and task 3, performed in that order. However, in this example, there may be a pre-existing maintenance plan that includes performing maintenance on machine 3 at a same time that task 3 is planned to be performed. This may cause delays in the activity, as task 3 may not be able to be performed on time by machine 3. Therefore, in this example, a replacement maintenance plan may be created that, for example, transfers task 3 to machine 4 (where machine 4 also has functionality 3), delays maintenance on machine 3 until after task 3 has been performed, performs maintenance on machine 3 while task 1 and/or task 2 are being performed, etc.

Method 201 includes operation 225 to update the maintenance plan based on sensor data. In some instances, sensor data may help determine various information about the machines and their functionalities and capabilities. The sensor data may detect new information about the machines, in some instances, that may affect the maintenance plan. For instance, the sensors may help indicate when a machine may need maintenance. In this example, the maintenance plan may be updated to include the new machine that needs maintenance.

In some instances, method 201 may be executed in response to determining that one or more machines need maintenance (for example, by determining that one or more machines are not functioning at their full capacity). In some instances, the machine(s) may have a notification, alert, pop-up, or some other type of indication that the machine(s) need maintenance. In some instances, routine checks may be performed on the machine(s), and it may be determined from routine checks that machine(s) need maintenance. In some instances, the system may gather data about the machine(s) from the machines themselves as well as, in some instances, one or more sensors attached, embedded, connected to, etc. the machine(s) and may analyze this data in order to determine whether machine(s) need maintenance. In some instances, it may be determined that a machine needs maintenance from any one or more of these methods.

In some instances, method 201 may be deployed as part of a factory, an assembly line, a fabrication plant, or any other large system. For example, there may be various machines and sensors, in some instances along with a computer, all connected as a system/process (for example, as one connected machine/process). For example, an assembly line, a shop floor, etc. may include multiple machines (for example, 30 machines), but every machine may be connected as one connected machine/system. All the functionalities and tasks being executed by the multiple machines may run automatically from start to finish, in this example. In some instances, the system, using method 201, may generate a maintenance plan (and, in some instances, update that maintenance plan) that can schedule maintenance, delay maintenance, coordinate the maintenance based on when the machine is used, etc. in order to optimize maintenance plans and prevent unnecessary downtime of the machines. When machines are connected as one system/process, maintenance to any of the machines may cause the system/process to be shut down due to the maintenance. Generating maintenance plan(s) may help improve the system/process, by coordinating maintenance, reducing downtime, and reducing the amount of shutdowns for the system/process due to maintenance. This may help prevent delays in activities and may help prevent machines from having to unnecessarily wait to execute tasks.

Further, generating and optimizing maintenance plans may help prevent using unnecessary bandwidth for the automated agents (for example, automated robots/bots) performing maintenance on the machines. For instance, the automated agent(s) may only have so much bandwidth that can be utilized for performing maintenance. If the automated agent(s) are continually having to perform maintenance on non-optimized maintenance schedules, excess bandwidth may need to be utilized in order to perform maintenance. By generating maintenance plans, considering downtime of machines, etc. the automated agent(s) may be able to perform maintenance at coordinated times (for example, at same/similar times), which may use less bandwidth of the automated agent(s).

Referring to FIG. 3, a method 300 for determining one or more sets of minimum functionalities required to perform an activity is depicted, according to some embodiments. Method 300 may correspond to operation 205 (FIG. 2), in some instances. Method 300 includes operation 305 to determine current functionalities performing an activity, operation 310 to determine capable functionalities of the machine(s), and operation 315 to determine one or more combinations of functionalities that could (i.e., are capable of) perform the activity.

As discussed herein, current functionalities may be the functionalities that, when maintenance is not being performed, are set to perform the activity. In some instances, determining current functionalities performing an activity (operation 305) may include identifying which functionalities are programmed/set to perform the activity. For example, when maintenance is not being performed, a first machine may perform a first functionality, a second machine may perform a second functionality, and a third machine may perform a third functionality. In this example, an activity may comprise the first, second, and third functionality, therefore. Therefore, in this example, as the first, second, and third functionalities are the functionalities that are programmed to be performed on their respective machines (when those machines are not undergoing maintenance), the first, second, and third functionalities may be the current functionalities.

As discussed herein, method 300 further includes determining capable functionalities of the machine(s) (operation 310). The capable functionalities may be the functionalities that the various machines (for example, the machines connected to the system) are capable of executing. In some instances, historical data may be used to determine capable functionalities of the machine(s). For example, historical data about the machine(s) and their various functionalities may have been gathered over time (for example, through various sensors on/connected to the machines, IoT, etc.), and the historical data for the machine(s) may include, for example, information about which functionalities the machine(s) have executed over time. In some instances, a system may be newly created and historical data may not exist. In these instances, the system may create historical data as activities are assigned and functionalities are determined. In some instances, even if a system is a newly created system, historical data may still be determined through deep learning (or any other kind of machine learning).

In some instances, machine specifications may be used to determine capable functionalities of the machine(s). For example, each machine may have is own specifications (for example, the capabilities the machine has, the different parts/equipment within the machine, etc.). In some instances, the machine specifications may be outlined/determined by the manufacturer of the machine. In some instances, the machine(s) may be registered and/or connected to the system using their serial number, vin number, location of the machine on the industrial floor, etc. In some instances, this registration and/or connection may allow the system access to the machine specifications.

In some instances, a knowledge corpus may be created (for example, using historical knowledge learning) that maps machines to their capable functionalities. In these instances, the capable functionalities of the machine(s) may be determined from the knowledge corpus.

Method 300 further includes operation 315 to determine one or more combinations of functionalities that could (e.g., are capable of) performing the activity. In some instances, determining one or more combinations of functionalities that could perform the activity includes identifying one or more tasks that make up the activity, determining one or more functionalities that correspond with the one or more tasks, and creating sets of the one or more functionalities that are capable of completing the one or more tasks. These sets may be referred to as combinations of functionalities.

In some instances (not depicted in method 300), identifying one or more sets of minimum functionalities may further include removing any unnecessary or non-essential functionalities from the one or more combinations of functionalities. Each combination of functionalities may be a set of minimum functionalities, in some instances. In some instances, combinations of functionalities with an amount of functionalities over a threshold amount of functionalities may not be a set of minimum functionalities. For example, a set of functionalities may include 12 functionalities, however, there may be a threshold amount of functionalities of 7. In this example, the set of functionalities with 12 functionalities may not be a set of minimum functionalities, as it may include an amount of functionalities over the threshold amount of 7.

Referring to FIG. 4, a method 400 for generating a maintenance plan is depicted, according to some embodiments. Method 400 may correspond to operation 220 (FIG. 2) in some instances. In some instances, generating a maintenance plan may include any one operation and/or combination of operations from method 400 (for example, generating a maintenance plan may not include every operation from method 400, in some instances).

Method 400 includes operation 405 to determine whether there are any sets from the one or more sets of minimum functionalities that involve only machines that do not need to undergo any maintenance. For example, current functionalities performing the activity may correspond to one or more machines that need to undergo maintenance. However, there may be another set of minimum functionalities that does not utilize the one or more machines that need to undergo maintenance. For example, there may be two machines that are capable of executing the same function (and, for instance, performing the same task), but only one of the two machines needs to undergo maintenance, therefore another set of minimum functionalities may include using the second machine to execute the functionality (instead of the first machine). In some instances, the maintenance plan may be to use the set of minimum functionalities that involves only machines that do not need to undergo any maintenance to perform the activity, and to perform maintenance on the machine that need maintenance.

Method 400 includes operation 410 to analyze execution plans for the machines capable of supporting the one or more sets of minimum functionalities. The execution plans may be the scheduled execution operations for each machine. For example, a first machine may be scheduled to execute a first functionality and a second functionality for a first activity and the first functionality for a second activity, a second machine may be scheduled to execute a third functionality for the first activity and a fourth functionality for the second activity, and a third machine may be scheduled to execute a fifth functionality for the second activity and a sixth functionality for a third activity. These various machines, functionalities, activities, interdependencies, execution timing, etc. may all be part of the execution plans for the machine(s).

Method 400 includes operation 415 to determine, from the analyzing, whether any of the machines capable of supporting the one or more sets of minimum functionalities are used in multiple activities. For instance, using the example above, the first machine may be used in a first and a second activity, a second machine may be used in the first and the second activity, and a third machine may be used in the second activity and in a third activity.

Method 400 includes operation 420 to determine, from the analyzing, any downtime of the machines. For example, there may be downtimes where a machine is not executing any functionalities, downtimes where a machine is executing a functionality unrelated to the functionality that needs maintenance, downtimes where a machine is executing a functionality for a different activity, etc. Knowing various downtimes of the machine(s) may help generate maintenance plans that minimize and/or optimize downtimes, so that the machine(s) are not down for maintenance any longer than needed.

Method 400 includes operation 425 to determine whether there are any alternate functionalities that may perform a task of the activity and/or whether there are any alternate machines that may execute a same functionality for the activity. For example, a pressing machine may have functionalities of flat pressing and texture pressing. In this example, there may be a task of pressing a material that is part of an activity. Typically, the pressing functionality that is utilized for this task may be flat pressing. However, the flat pressing functionality of the machine may need maintenance. In this example, texture pressing may be an alternate functionality that achieves the same task of pressing a material.

In another example, there may be two machines that are both capable of flat pressing. The flat pressing functionality of a first machine may typically be used for the activity, however in this example, the flat pressing functionality of the first machine may need to undergo maintenance. Therefore, in this example, the second machine may be an alternate machine that can execute the flat pressing functionality.

In some instances, any one or more of these operations may be used to help generate a maintenance plan. For example, if all the interdependent machines need maintenance, there may be an option to send the task(s) or activity to a different set of machines or wait for the machines to undergo maintenance. In this example, there may also be the option to try and time maintenance so that the only delay is the downtime of the first machine. For example, only the first machine may need maintenance. Or, in another example, the downtime of the other machines can be organized/planned to occur while a task is being executed on a different machine, therefore optimizing the downtime to a time where the machine is not being utilized. In another example, downtime for maintenance may occur proactively while another machine (for example machine 2) is in progress, therefore by the time machine 2 finishes its task, machine 3 is already done with maintenance or only has a minimal time left of maintenance. In some instances, a functionality may need to undergo maintenance, however the machine may be able to adjust its operations to continue executing the functionality until the machine has scheduled downtime. For example, a machine may typically only need to press once in order to flat press a material, however, the press may be losing force and may need to undergo maintenance. In this example, the machine may be able to press twice in order to flat press the material (instead of the typical once) until the machine has downtime that can be utilized for maintenance.

In some instances, the capabilities/functionalities of a machine can be reduced and the remaining portions of the capabilities/functionalities can be augmented to machines that also have those functionalities, in order to help prevent downtime. For example, a machine is executing functionality 1, which is transporting an item from machine 1 to machine 2, but because of a track of the machine needing maintenance, the track can only get the item halfway to machine 2. So, in this example, an additional piece of equipment can be augmented that has the capability/functionality to pick up the item halfway and get it to machine 2, in order to prevent downtime of the machine(s) and allow for the activity to be continued.

In some instances, the various factors/data from operations 405, 410, 415, 420, and/or 425 may be optimized (for example, through artificial intelligence (AI) optimization) in order to generate a maintenance plan that helps optimize and/or minimize downtime of the machines.

Referring to FIG. 5, a schematic diagram of an example IoT environment 500 is depicted, according to some embodiments. IoT environment 500 may execute methods 201 (FIG. 2) and/or 300 (FIG. 3), in some instances. IoT environment 500 includes a system 510 and machine 520, machine 530, and machine 540, all connected by a network 505. Although three machines (520, 530, and 540) are depicted, IoT environment 500 may include any number of machines.

In some instances, as depicted in FIG. 5, each machine may include and/or be connected to one or more sensors (525, 535, and 545). These sensors may be used to help determine when the machines 520, 530, and 540 need maintenance, gather data about the functionalities, activities, and interconnectivities of the machines 520, 530, and 540, etc. For IoT environment 500, machine 520 includes sensor 525, machine 530 is connected to sensor 535, and machine 540 includes sensor 545. Although FIG. 5 depicts a single sensor (525, 535, and 545) for each machine (520, 530, and 540), the machines may include and/or be connected to any number of sensors. In some instances, as depicted for machines 520 and 540, the machine may include the sensor(s) (525 and 545, respectively). In some instances, as depicted for machine 530, the machine may be connected to the sensor(s) 535. In some instances, the machine(s) may both include one or more sensors and be connected to one or more sensors. The machines 520, 530, and 540 may transmit the sensor data over a network 505 to the system 510, in some instances, and the system 510 may determine a maintenance plan for maintenance on one or more of the machines 520, 530, and 540.

In some instances (not depicted), IoT environment 500 may include an automated bot that is part of the system 510, connected to the system 510, etc. The automated bot may perform maintenance on the machines 520, 530, 540. In some instances, after generating and/or updating maintenance plan(s) of the machines 520, 530, 540, the system 510 may automatically send a signal to the automated bot to perform maintenance on the machines 520, 530, 540 based on (for example, in accordance with) the maintenance plan(s).

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, the method comprising:
determining one or more sets of minimum functionalities required to perform an activity;
determining machines capable of supporting the one or more sets of minimum functionalities;
determining a minimal level of maintenance for the machines; and
generating a maintenance plan for one or more of the machines based on the minimal level of maintenance for the machines.

2. The method of claim 1, wherein generating the maintenance plan comprises:
analyzing execution plans for the machines capable of supporting the one or more sets of minimum functionalities; and
determining, from the analyzing, downtime of the machines.

3. The method of claim 1, wherein generating the maintenance plan comprises:
determining whether there are any sets from the one or more sets of minimum functionalities that involve only machines that do not need to undergo maintenance.

4. The method of claim 1, wherein determining the one or more sets of minimum functionalities required to perform the activity comprises:
determining current functionalities performing an activity;
determining capable functionalities of one or more machines; and
determining one or more combinations of functionalities from the current functionalities and the capable functionalities that are capable of performing the activity.

5. The method of claim 4, wherein determining current functionalities performing an activity comprises:
identifying which functionalities are programmed to perform the activity.

6. The method of claim 4, wherein determining one or more combinations of functionalities that are capable of performing the activity comprises:
identifying one or more tasks that make up the activity;
determining one or more functionalities that are capable of completing the one or more tasks; and
creating sets of the one or more functionalities that are capable of completing the one or more tasks.

7. The method of claim 1, wherein the maintenance plan includes an optimal time to perform maintenance on the one or more of the machines.

8. The method of claim 1, further comprising:
analyzing an existing maintenance plan;
identifying a problem likely to be caused by the existing maintenance plan;
generating a replacement maintenance plan that addresses the problem, wherein the generating the maintenance plan comprises generating the replacement maintenance plan; and
replacing the existing maintenance plan with the replacement maintenance plan.

9. The method of claim 1, wherein determining the minimal level of maintenance comprises:
analyzing interdependencies between activities and machines; and
determining whether one or more machines are used to accomplish multiple activities.

10. The method of claim 1, further comprising:
determining that one or more machines need maintenance.

11. The method of claim 1, wherein the maintenance plan includes one or more of a machine to undergo maintenance, functionalities of the machine that need maintenance, time to perform the maintenance, and an activity execution plan while the machine undergoes maintenance.

12. A system having one or more computer processors, the system configured to:
determine one or more sets of minimum functionalities required to perform an activity;
determine machines capable of supporting the one or more sets of minimum functionalities;
determine a minimal level of maintenance for the machines; and
generate a maintenance plan for one or more of the machines based on the minimal level of maintenance for the machines.

13. The system of claim 12, wherein generating the maintenance plan comprises:
analyzing execution plans for the machines capable of supporting the one or more sets of minimum functionalities; and
determining, from the analyzing, downtime of the machines.

14. The system of claim 12, wherein determining the one or more sets of minimum functionalities required to perform the activity comprises:
determining current functionalities performing an activity;
determining capable functionalities of one or more machines; and
determining one or more combinations of functionalities from the current functionalities and the capable functionalities that are capable of performing the activity.

15. The system of claim 14, wherein determining one or more combinations of functionalities that are capable of performing the activity comprises:
identifying one or more tasks that make up the activity;
determining one or more functionalities that are capable of completing the one or more tasks; and
creating sets of the one or more functionalities that are capable of completing the one or more tasks.

16. The system of claim 12, further configured to:
analyze an existing maintenance plan;
identify a problem likely to be caused by the existing maintenance plan;
generate a replacement maintenance plan that addresses the problem, wherein the generating the maintenance plan comprises generating the replacement maintenance plan; and
replace the existing maintenance plan with the replacement maintenance plan.

17. A computer program product comprising a computer readable storage medium having program instructions embodied therewith, the program instructions executable by a server to cause the server to perform a method, the method comprising:
determining one or more sets of minimum functionalities required to perform an activity;
determining machines capable of supporting the one or more sets of minimum functionalities;
determining a minimal level of maintenance for the machines; and
generating a maintenance plan for one or more of the machines based on the minimal level of maintenance for the machines.

18. The computer program product of claim 17, wherein generating the maintenance plan comprises:
analyzing execution plans for the machines capable of supporting the one or more sets of minimum functionalities; and
determining, from the analyzing, downtime of the machines.

19. The computer program product of claim 17, wherein determining the one or more sets of minimum functionalities required to perform the activity comprises:
determining current functionalities performing an activity;
determining capable functionalities of one or more machines; and
determining one or more combinations of functionalities from the current functionalities and the capable functionalities that are capable of performing the activity.

20. The computer program product of claim 17, further comprising:
analyzing an existing maintenance plan;
identifying a problem likely to be caused by the existing maintenance plan;
generating a replacement maintenance plan that addresses the problem, wherein the generating the maintenance plan comprises generating the replacement maintenance plan; and
replacing the existing maintenance plan with the replacement maintenance plan.
